(19) United States
(12) Patent Application Publication
(10) Pub. No.: US 2008/0118687 A1
(43) Pub. Date: May 22, 2008

(54) Memory impregnated thermoplastic article

(76) Inventors: Alex Andrew Burns, (US); Jonathan C. Fellers, St. Petersburg, FL (US); Gang Yao, Pinellas Park, FL (US)

Correspondence Address: Nancy A. Pappas;Life Sciences, Inc., 2900 72nd Street North, St. Petersburg, FL, 33710, US

(21) Appl. No.: 11/601,789

(22) Filed: Nov. 20, 2006

(51) Int. Cl. B32B 1/08

(52) U.S. Cl. 428/35.7

(57) ABSTRACT

Molded polymer structures, including tubes, plates, cards, bottles, etc. are formed with doped, silica nanoparticles on or with in the polymer matrix. Prior to the thermoforming operation, the nanoparticles may be doped with single or multiple signal producing molecules, which are detectable by optical, electrical, and/or magnetic means. The nanoparticles may be visible or invisible to the naked eye.

This invention was made with Government support under grant number NIH/NIAID 5R41AI060321-02, awarded by the National Institutes of Health. Therefore, the Government may have certain rights in the invention.

### CROSS REFERENCE TO RELATED APPLICATIONS

There are no applicable applications.

### FIELD OF THE INVENTION

This invention relates to the use of dye-doped nanoparticles as identification markers in laboratory testing vessels. More particularly, this invention relates to the incorporation of nanoparticles into a tube, bottle or other thermoplastic containers used in laboratory environments either as fillers in the thermoplastic matrix itself or applied as a coating on any of the surfaces of the vessels to provide an indelible marking system within the matrix of the vessel itself.

### BACKGROUND OF THE INVENTION

In the field of biological and chemical testing, the need for identification of sample tubes or other vessels is paramount to the process of testing. In a clinical setting it is highly important that sample vessels are accurately marked to ensure proper correlation of the results to the specific patient tested. Labeling of the sample vessels needs to be efficient and secure enough to permit the sample to be manipulated into test equipment and storage facilities without the chance for loss of the identification markers.

Current labeling techniques involve printed labels applied to the outer surface of the vessel which may become damaged during handling. In addition, where test equipment is involved, there is a possibility that the label may need to be removed prior to insertion in the test equipment, thus resulting in the possible loss of the tube's identity after the test is performed. Alternately, samples have to be transferred to other tubes or containers for testing which can result in loss of the identification label.

Various methods for production of laboratory testing vessels are used today. These include blow-molding, injection-molding, press and vacuum molding as well as other recognized methods of producing hollow vessels. In these methods, thermoplastics are deformed to produce a final shape usable for particular applications. The mass-produced vessels can either be used as they were produced or they may be subject to post-processing treatments such as coating, sterilizing or pre-filling of chemical species.

In the past, it has been proposed to color code the test vessels in order to identify specific tubes in an array. One such reference to this is U.S. Pat. No. 5,670,118 to Sponholtz. In his disclosure, Sponholtz describes a color coded surface which appears as a ring around a portion of the tube. In particular, the color is an ultraviolet cured ink which serves to identify the tube by its appearance of the surface of the tube. The coating is applied by a variety of means such as screen-printing or hot stamping.

In recent years the use of nanoparticles has become more popular for carrying encoded information. The incorporation of both magnetic and non-magnetic materials has become more widely used in these applications and materials such as fluorescent dyes have even been synthesized into the nanoparticles to permit use as biomarkers. One example of such a system is disclosed in Tan et al., U.S. Pat. No. 6,548,264. Here a variety of materials may be incorporated into a silica-coated nanoparticle matrix depending on the final desired product.

### SUMMARY OF THE INVENTION

It is therefore an object of the invention to provide a system that is capable of encoding information into or onto a laboratory vessel using nanoparticles as the vehicle of the encoding. The nanoparticles of the invention may be coated onto any surface such as exterior or interior walls, the bottom of the vessel and also on a cap structure if present. The nanoparticles of the invention may be dye-doped or magnetically charged or any combination thereof. In addition, the nanoparticles may contain a plurality of encoding dyes or a have a plurality of different types of magnetically chargeable cores.

The dye-doped nanoparticles may also be applied or incorporated into the tube structure in any type of patterning so that when excited by the proper wavelength for the dye, a corresponding pattern emerges that represents the identification. The scope of the invention also includes use of single and multiple signal molecules as well as multiple varieties of molecules. In addition, a plurality of differing dye-doped nanoparticles may be coated onto the surface of any vessel in a random or patterned fashion and these coatings may include a plurality of surfaces as well.

The nanoparticles may be detected by any well known technique such as optical, visual, electrical and/or magnetic means. In addition, any pattern may be formed by a single type of particle or a combination of different dye-containing particles as well as patterns formed which also include magnetic particles.

### DETAILED DESCRIPTION OF THE DRAWINGS

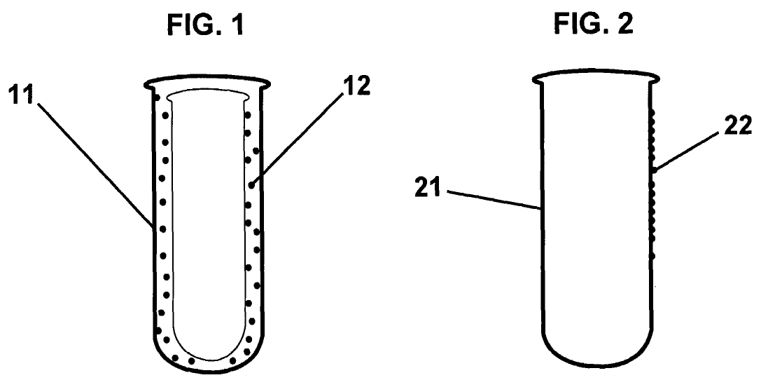

FIG. 1 is a depiction of a tube type of vessel having nanoparticle incorporated within the polymer matrix.

FIG. 2 is a further depiction of a tube type vessel having a nanoparticle coating applied to the exterior walls of the tube.

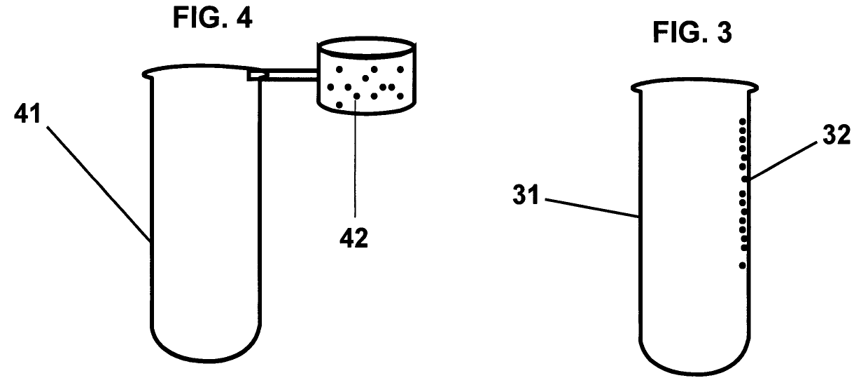

FIG. 3 is another example of a tube type vessel having a nanoparticle coating applied to an interior surface thereof.

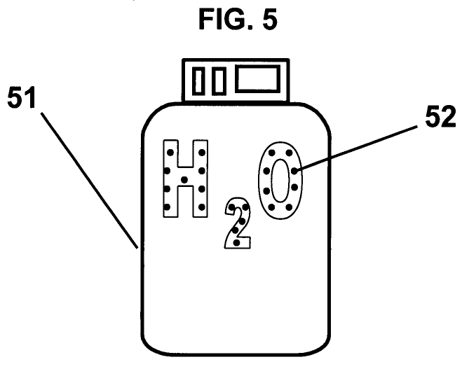

FIG. 4 is yet another example of a tube type vessel having a nanoparticle coating applied to a cap feature.

FIG. 5 shows a bottle type vessel having a patterned type of nanoparticle coating.

### DETAILED DESCRIPTION OF THE INVENTION

The nanoparticles of the present invention include any type of nanoparticles, but of special interest are those synthesized by either Stöber or reverse microemulsion methods. One type of such nanoparticles are those disclosed by Tan et al. The nanoparticles contain single or multiple signal molecules, which can be detected by visually or through instrumental (optical, electrical, magnetic) means. Any combination of detection systems is incorporated. Of particular interest are nanoparticles with protective layers to shield the internal signaling contents from stresses encountered during vessel processing such as high temperature, increased pressure, and storage. Modifications to the surface of nanoparticles to improve incorporation in thermoplastic are also of interest.

As shown in FIG. 1, the tube shaped vessel 11 is formed with nanoparticles 12 incorporated into the polymer matrix prior to the forming of the tube. In this example, the nanoparticles used may also have a protective coating thereon to prevent damage during the processing of the final vessel. The nanoparticles may be either magnetic, non-magnetic or both and may possess a dye element or a plurality of dye elements inside the protective core layer. In addition, a plurality of differing dyes nanoparticles may be used. Thus detection of the identifier element may be made via any optical, visual, electrical or magnetic means as well as encoding of information may be made if the particles are magnetic in nature.

An additional tube vessel of another type is shown in FIG. 2. Here a coating of nanoparticles 22 is applied to an exterior portion of the tube 21 the extent of which may encompass the whole outer surface of the tube or any portion thereof. In addition the nanoparticle coating may be applied in a pattern so that identification of the tube is more specific under a broad spectrum of wavelengths including the UV, IR and visible ranges. Again the nanoparticles may be magnetic, non-magnetic or both and may possess a single or multiple dye components. In addition, a plurality of nanoparticle coatings of different dyes may be applied if so desired. These coatings may be applied in a single application or in a plurality of coating steps.

FIG. 3 is a further example of a tube type vessel 31 with the nanoparticle coating 32 applied to the interior surface of the tube. In this instance, again, the coating may be partial or cover the whole inner surface of the tube and the nature of the particles and dyes may be the same as those of the previous examples.

A further embodiment is shown in FIG. 4. Here a cap feature 43 is mounted on the top of the tube type vessel 41 having nanoparticles 42 incorporated therein. As in the previous examples, the nanoparticles may be coated on the outside surface, the inside surface or, as shown, inside the polymer matrix itself. As in the previous embodiments, the nature of the nanoparticles 42 themselves is a choice available to one of ordinary skill in the art.

FIG. 5 shows another embodiment wherein a bottle type of vessel 51 is coated with a patterned type of nanoparticle coating 52. In this instance the pattern may be visible under ambient light conditions or may be excited by fluorescent or other wavelengths. In addition the pattern may be of a single type or a plurality of types of nanoparticles.

The vessels 11, 21, 31, 41 and 51 may be formed of any suitable thermoplastic material available to those of ordinary skill in the art. These include, but are not limited to, polyethylene, polypropylene, polyesters, polycarbonates, polyamides, liquid crystal polymers, fluoropolymers, polyvinyl chlorides, ABS resins.

The nanoparticles 12, 22, 32, 42, and 52 most suitable for use in the invention are those described in Tan et al., and preferably have a core matrix with a dye component encapsulated with silica as an outer or shell layer. These may be formed by any suitable means such as reverse microemulsion or the Stöber method. The dye component may be selected from any suitable dyes including but not limited to acridines, anthraquinones, arylmethanes (diaryl methanes, triaryl methanes), azo dyes, benzofurazans, BODIPY's, coumarins, cyanines, diazoniums, napthalenes, nitro dyes, nitroso dyes, pthalocyanines, pyrenes, quinine-imines (eurhodins, saphranins, indamins, indophenols, oxazins, oxazones, thiazins, thiazoles), xanthenes (pyronins, rhodamines, fluorones), metal complexes (lanthanide chelates). It is understood that these selections are available to those of ordinary skill in the art as desired by the choice of detection system and application.

Other nanoparticles contemplated by the invention are those which contain a pigment, including both inorganic and organic pigment compounds and combinations. Suitable pigments include biological (Alizarin, Alizarin Crimson, Gamboge, Indigo, Indian Yellow, Cochineal Red, Tyrian Purple, Rose madder), Carbon (Carbon Black, Ivory Black, Vine Black, Lamp Black), Cadmium (Cadmium Green, Cadmium Red, Cadmium Yellow, Cadmium Orange), Iron Oxide (Caput Mortuum, oxide red, Red Ochre, Sanguine, Venetian Red, Mars Black), Chromium (Chrome Green, Chrome Yellow), Cobalt (Cobalt Blue, Cerulean Blue, Cobalt Violet, Aureolin), Lead (lead white, Naples yellow, Cremnitz White, red lead), Copper (Paris Green, Verdigris, Viridian), Titanium (Titanium White, Titanium Beige), Ultramarine (Ultramarine, Ultramarine Green Shade, French Ultramarine), Mercury (Vermilion), Zinc (Zinc White), clay earth (Raw Sienna, Burnt Sienna, Raw Umber, Burnt Umber, Yellow Ochre), organic (Pigment Red 170, Phthalo Green, Phthalo Blue, Prussian blue, Quinacridone Magenta).

Additional dyes, pigments, and luminescent compounds are understood to be included without direct mention to those of ordinary skill in the art.

In addition, magnetic materials may comprise a portion of the core component of the nanoparticles and these serve to permit encoding of the particles where that feature is so desired. These materials include, but are not limited to, ferromagnetic oxides and hematites.

Semiconductors such as quantum dots may also be used.

The outer layers of the nanoparticles may be comprised of silica, carbon, titanium oxides, alumina, zeolites, zirconia or other similar materials that form inorganic glasses as known to those of ordinary skill in the art. The selection of the particular material is again a matter of choice dependent on the application.

Various shapes other than those depicted are considered within the scope of the invention. These include tubes such as centrifuge and test tubes, bottles, pipettes, microtiter plates, etc. It is considered within the scope of ordinary skill in the art that any product that is formed via thermo-deformation is capable of being made with the nanoparticles included as either a coating or a filling in the thermoplastic material itself, those vessels being both hollow and solid in nature and flat or shaped into any shape. Indeed, any plastic article formed of a thermoplastic or coated with a thermoplastic material is suitable for the filled resins herein disclosed. The resins are particularly suitable for applications wherein a security feature may be desired, since the nanoparticles may be used to encode information that is tamperproof in these applications.

Modification and variation can be made to the disclosed embodiment of the instant invention without departing from the scope of the invention as described. Those skilled in the art will appreciate that the applications of the present invention herein are varied, and that the invention is described in the preferred embodiment. Accordingly, additions and modifications can be made without departing from the principles of the invention. Particularly with respect to the claims, it should be understood that changes may be made without departing from the essence of this invention. In this regard, it is intended that such changes would still fall within the scope of the present invention. Therefore, this invention is not limited to the particular embodiments disclosed, but is intended to cover modifications within the spirit and scope of the present invention as defined in the appended claims.

We claim:

1. A shaped thermoplastic vessel comprising:
a. a thermoplastic resin matrix; and
b. a plurality of nanoparticles containing an element for encoding information.

2. The shaped thermoplastic vessel of claim 1, wherein the nanoparticles are contained within the resin matrix.

3. The shaped thermoplastic vessel of claim 1, wherein the nanoparticles are coated onto the resin matrix.

4. The shaped thermoplastic vessel of claim 3, wherein the nanoparticles are coated onto an outer surface of the shaped vessel.

5. The shaped thermoplastic vessel of claim 3, wherein the nanoparticles are coated onto an inner surface of the shaped vessel.

6. The shaped thermoplastic vessel of claim 1, wherein the nanoparticles are dye-doped nanoparticles.

7. The shaped thermoplastic vessel of claim 6, wherein the dye-doped nanoparticles contain a plurality of dye elements.

8. The shaped thermoplastic vessel of claim 6, wherein the dye-doped nanoparticles produce a single signal.

9. The shaped thermoplastic vessel of claim 6, wherein the dye-doped nanoparticles produce multiple signals.

10. The shaped thermoplastic vessel of claim 6 wherein the dye component is a fluorescent dye.

11. The shaped thermoplastic vessel of claim 1, wherein the nanoparticles contain a magnetic element.

12. The shaped thermoplastic vessel of claim 1, wherein the nanoparticles have a protective outer layer encapsulating the information encoding element.

13. The shaped thermoplastic vessel of claim 1, wherein the information encoding element is visible in nature.

14. The shaped thermoplastic vessel of claim 1, wherein the information encoding element is detectable via instrumental means.

15. The shaped thermoplastic vessel of claim 1, wherein the nanoparticles contain a pigment.

16. The shaped thermoplastic vessel of claim 1, wherein the vessel shape is tubular.

17. The shaped thermoplastic vessel of claim 1, wherein the vessel is formed via blow-molding.

18. A thermoplastic article comprising:
a. a thermoplastic resin matrix; and
b. a plurality of dye-doped nanoparticles.

19. The thermoplastic article of claim 18, wherein the dye element is a fluorescent dye.

20. The thermoplastic article of claim 18, wherein the dye-doped nanoparticles are encapsulated.
